(19) United States
(12) Patent Application Publication
(10) Pub. No.: US 2023/0332465 A1
(43) Pub. Date: Oct. 19, 2023

(54) WINDOW COVERING

(71) Applicant: Cortina Curtains Inc., Woodbridge (CA)

(72) Inventors: Chris DIMITRAKOUDIS, Toronto (CA); James TULSIDIN, Vaughan (CA); Peter DIMITRAKOUDIS, Toronto (CA)

(21) Appl. No.: 17/723,944

(22) Filed: Apr. 19, 2022

(51) Int. Cl. E06B 9/42; E06B 9/74

(52) U.S. Cl. CPC E06B 9/42; E06B 9/74; E06B 2009/2405

(57) ABSTRACT

A window covering is described. The window covering has a first tube and a second tube rotatably coupled to the first tube. The first tube and the second tube are disposed along parallel axes. A fabric is fastened at a first end to the first tube and at a second end to the second tube. A tensioning bar is slidably disposed along the fabric in between the first end and the second end. A bracket suspends the first tube and the second tube above the tensioning bar. The described window covering can be made to provide varying levels of privacy along an upper portion or lower portion of a window to be covered.

### TECHNICAL FIELD

The following relates generally to a window covering, and more specifically, to a retractable blind that provides selective privacy at any various portions thereof.

### BACKGROUND

Various types of window coverings are well known. A typical roller blind, for example, has a tube rotatable about a horizontal axis with a pair of mounting brackets at each end thereof, which are affixed proximate the top of the window. Rotation is achieved by actuating a clutch that is driven by a chain drive or electrical motor. A rectangular fabric serves as the window covering. A horizontal side of the fabric is affixed to the tube by adhesive or a retaining assembly of the tube and is rolled about the tube between an open position in which the window is exposed and a closed position in which the fabric is unrolled so that the length of the fabric rolls down to cover the window in a closed position. Rotation can typically be stopped at any desirable location between the open and closed positions. Therefore, it is possible to obscure some desired portion of the window to achieve a partial covering, with the covering being of an upper portion of the window and exposure of the lower portion of the window.

Other types of window coverings offer some advantages over roller blinds, one of which may be the ability to achieve a partial window covering in which the lower portion of the window is obscured while exposing the other portions of the window.

It is an object of the following to obviate or mitigate disadvantages of the foregoing.

### SUMMARY

There is provided a window covering comprising: a first tube and a second tube rotatably coupled to the first tube, the first tube and the second tube disposed along parallel axes; a fabric fastened at a first end to the first tube and at a second end to the second tube; a tensioning bar slidably disposed along the fabric in between the first end and the second end; and a bracket to suspend the first tube and the second tube above the tensioning bar.

In embodiments, the first tube and the second tube each have a gear disposed along its respective axis, wherein the gear of the first tube is coupled to the gear of the second tube.

In embodiments, one of the two gears are driven by a drive source.

In embodiments, the drive source is an electric motor.

In embodiments, the drive source is a clutch rotated by a manually drive.

In embodiments, the tensioning bar comprises an upper slot and a channel formed from the upper slot around a rolling bar.

In embodiments, the first tube, the second tube and the tensioning bar are substantially similar in length.

In embodiments, the fabric comprises three portions.

In embodiments, the three portions comprise a first portion from the first end to a first meeting line, a second portion from the first meeting line to a second meeting line, and a third portion from the second meeting line to the second end.

In embodiments, the first portion and the third portion are translucent and the second portion is more opaque than the first portion and the third portion.

In embodiments, each of the three portions is at least as long as a height of a window to be covered.

In embodiments, a length of the second portion plus a height of a tube assembly comprising the first tube and second tube is at least the height of a window to be covered.

In embodiments, when the first tube and the second tube are rotated, the fabric unrolls and the tensioning bar lowers until the fabric has fully unrolled from either the first tube or the second tube.

In embodiments, when the tensioning bar has reached a lowest extent, rotation of the first tube and second tube cause the fabric to traverse the tensioning bar passing the second portion from a first side of the tensioning bar to a second side of the tensioning bar.

In embodiments, the window covering can be configured to fully obscure a window, fully expose the window, or to obscure only a lower portion of the window.

These and other aspects are contemplated and described herein. It will be appreciated that the foregoing summary sets out representative aspects of the embodiments to assist skilled readers in understanding the following detailed description.

### DESCRIPTION OF THE DRAWINGS

A greater understanding of the embodiments will be had with reference to the Figures, in which:

FIG. 1 is an exploded front view of a window covering;

FIG. 2A is a top down view of a tensioning bar;

FIG. 2B is a front perspective view of a tensioning bar;

FIG. 3 is a cross-sectional side view of a tensioning bar;

FIG. 4 is a front view of a fabric;

FIG. 5A, FIG. 5B and FIG. 5C are side views of a window covering in varying positions;

FIG. 6A, FIG. 6B and FIG. 6C are front perspective views of a fabric in varying positions;

FIG. 7 is a front perspective view of a finished window covering embodying the teachings of the present specification;

FIG. 8 is a front view of the window covering of FIG. 7 in a retracted position;

FIG. 9 is a rear view of the window covering of FIG. 7 in the retracted position;

FIG. 10 is a right side view of the window covering of FIG. 7 G in the retracted position;

FIG. 11 is a left side view of the window covering of FIG. 7 in the retracted position;

FIG. 12 is a top view of the window covering of FIG. 7;

FIG. 13 is a bottom view of the window covering of FIG. 7;

FIG. 14 is a front perspective view of the window covering of FIG. 7 as it is being extended from the retracted position to an extended position;

FIG. 15 is a front perspective view of the window covering of FIG. 7 in a first extended position;

FIG. 16 is a front perspective view of the window covering of FIG. 7 in a second extended position.

### DETAILED DESCRIPTION

Embodiments will now be described with reference to the figures. For simplicity and clarity of illustration, where considered appropriate, reference numerals may be repeated among the Figures to indicate corresponding or analogous elements. In addition, numerous specific details are set forth in order to provide a thorough understanding of the embodiments described herein. However, it will be understood by those of ordinary skill in the art that the embodiments described herein may be practised without these specific details. In other instances, well-known methods, procedures and components have not been described in detail so as not to obscure the embodiments described herein. Also, the description is not to be considered as limiting the scope of the embodiments described herein.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative” or “exemplifying” and not necessarily as “preferred” over other embodiments. Further definitions for terms may be set out herein; these may apply to prior and subsequent instances of those terms, as will be understood from a reading of the present description.

The following relates generally to a window covering, and more specifically, to a retractable blind that provides selective privacy at any various portions thereof.

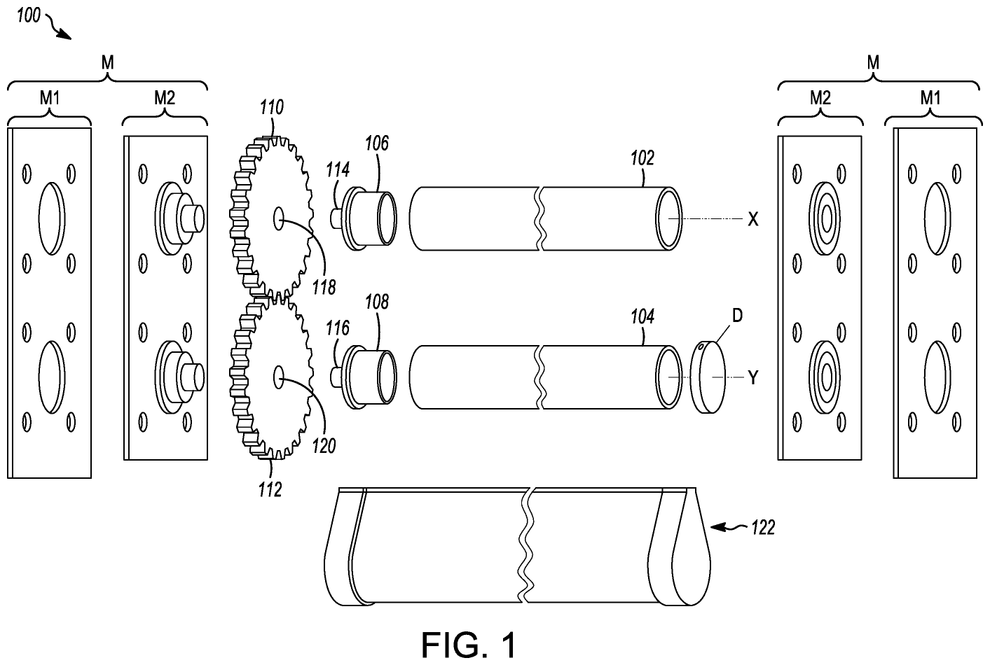

Referring first to FIG. 1, an embodiment of the window covering is shown. The window covering 100 comprises a first tube 102 and second tube 104 disposed along parallel axes X and Y, respectively. The first tube 102 and second tube 104 can be made of variable length to suit the particular window to be covered, as is known to the skilled person, and are sufficiently spaced apart to permit rolling of a fabric about one of the tubes without interfering with rotation of the other tube.

At one end of each of the tubes is a side plug 106, 108. Each side plug 106, 108 mates to a corresponding gear 110, 112. This could be achieved, for example, by a protuberance of the side plug 106, 108 receivable within an aperture 118, 120 of the gear 106, 108. Alternatively, the side plugs 106, 108 can include the gear 110, 112 in other words being formed of a unitary structure.

The gears 110, 112 are rotatably coupled so that rotation of one of the gears causes rotation in the opposite direction of the other one of the gears. It is possible that additional gears could be utilized and that the resulting rotation of the tubes could be in the same direction with appropriate adjustments to the remaining portions of the window covering.

One of the gears 110, 112 is driven by a drive source D which could be a manual drive such as a rope, wire or chain that rotates a clutch; or could be an electric motor operating from battery or wired power. In the illustration, drive source D drives the lower of the two gears 112. The tube being driven the drive source may be slightly shorter than the other tube, in order to account for the width of the drive source. The drive source D could alternatively drive the upper of the two gears 110.

The horizontal extents of the blind comprise mounting hardware M, the details of which are well known. Mounting hardware typically comprises a pair of brackets M1 fastened to the window, the windowsill or a wall or ceiling proximate the window. A coupling component M2 is affixed to the tubes and permits rotation of the tubes relative to the brackets M1. Preferably, the brackets are formed to permit temporary removal of either or both tubes, which is useful during installation or servicing.

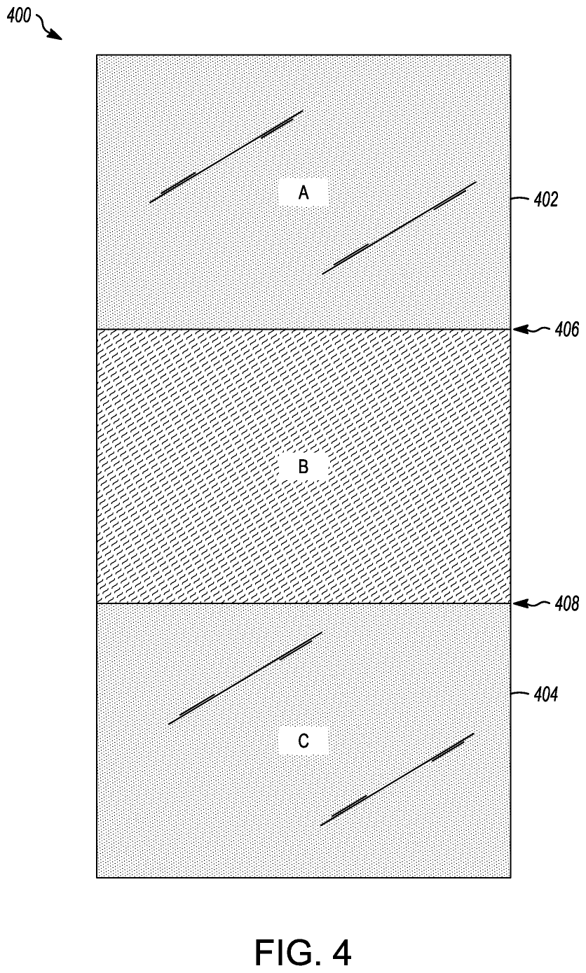

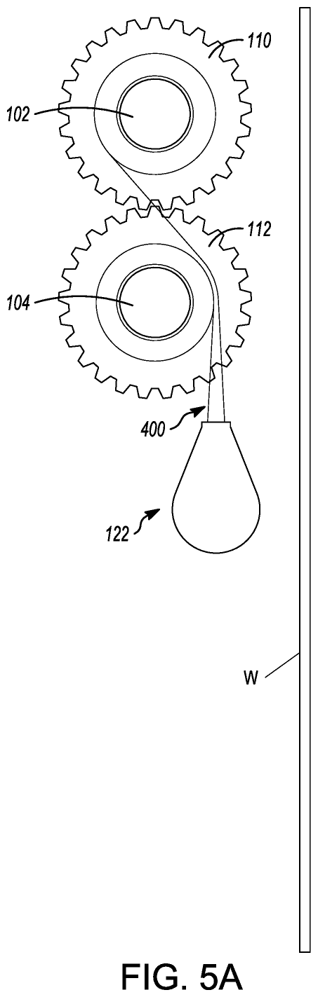

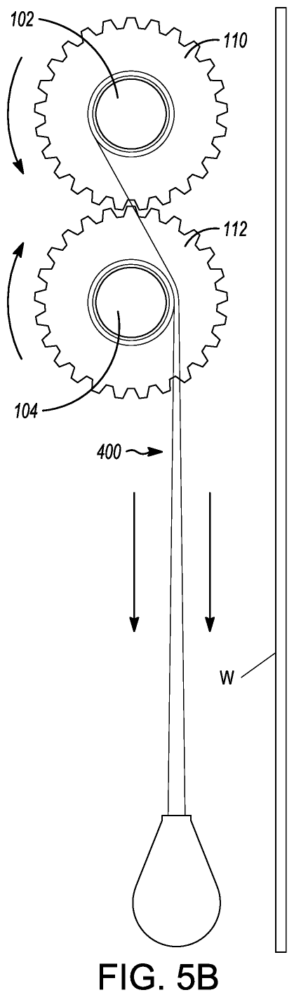

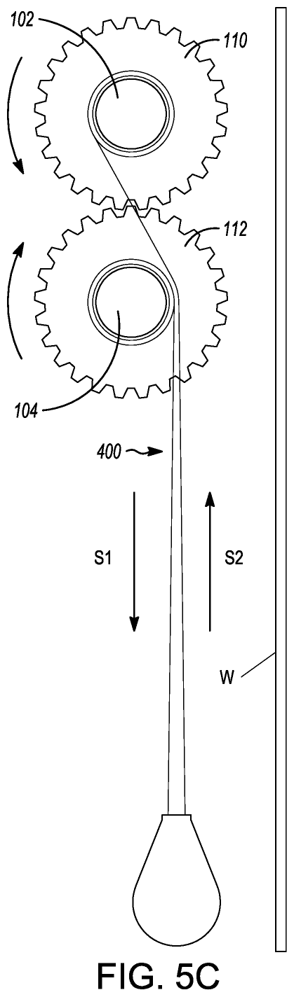

The blind further comprises a fabric, illustrated in FIG. 4 and FIGS. 5A to 5C. The fabric 400 is a continuous sheet that is affixed at one end to the first tube 102 and at the other end to second tube 104. The means of affixing the fabric to the tubes may be by adhesive or a retaining assembly formed into the tubes, as is known.

Also provided is a tensioning bar 122 of substantially equal length to the tubes 102, 104, accounting for the slight difference in the length of the two tubes. The length of the tubes and tensioning bar merely require accommodating the width of the fabric, as would be readily understood.

A skilled reader will appreciate that the operation of the window covering 100 may require additional components, such as plates, bushing, bearings, brackets, covers and housings, and that the appearance thereof may be improved with fascia or other coverings.

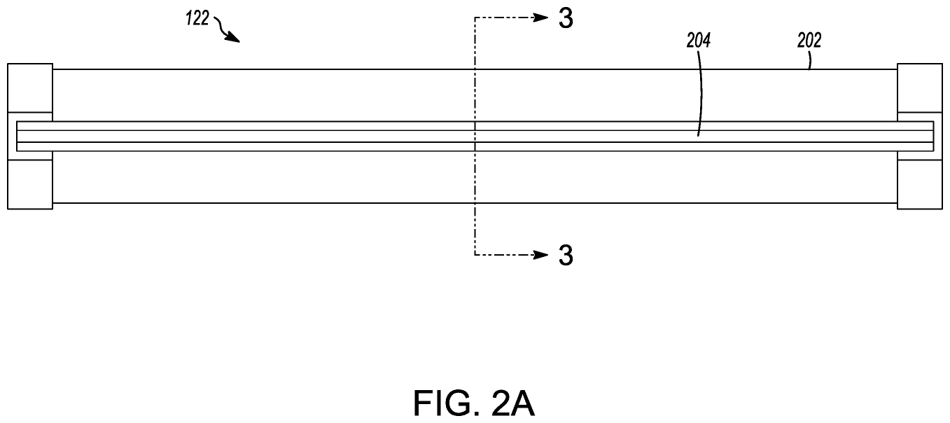

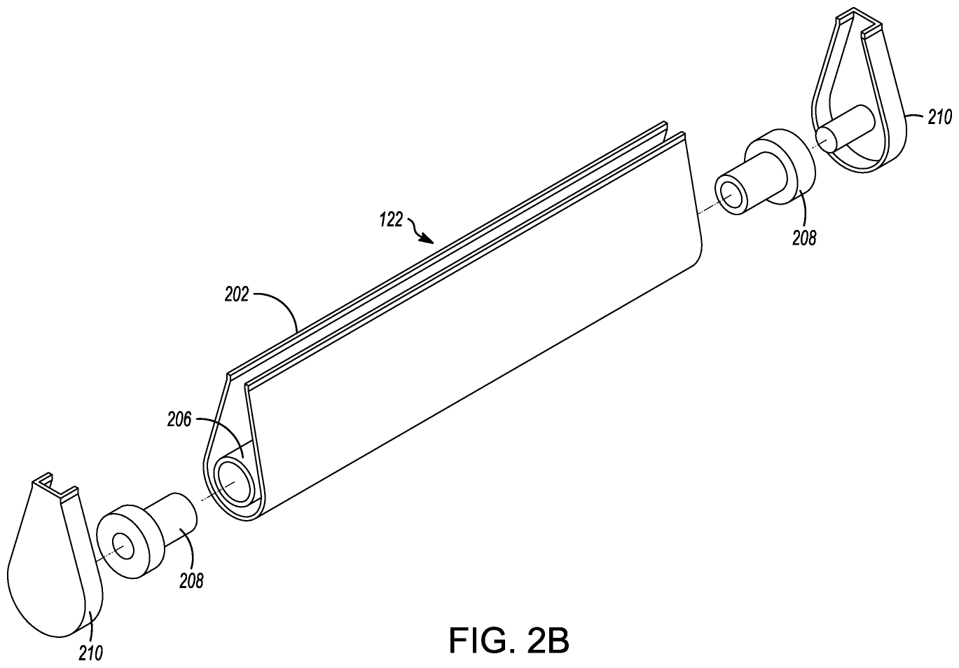

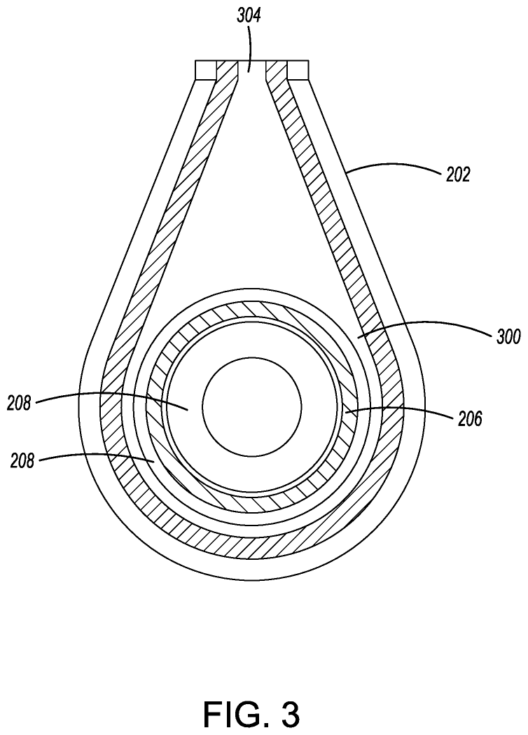

FIG. 2A illustrates a top-down view of an embodiment of the tensioning bar, FIG. 2B illustrates an exploded perspective view thereof, and FIG. 2C illustrates components thereof. FIG. 3 illustrates a cross-sectional side view of the tensioning bar. The tensioning bar 122 includes a housing 202 defining an upwardly facing slot 204, and a rolling bar 206 rotationally coupled within the housing 202. The length of the rolling bar is preferably substantially identical in length to the driven tube 104 and the housing 202 is slightly longer, preferably about ⅛″ longer.

The rolling bar 206 has a pair of end caps 208 at its ends, or these end caps can be integrally formed into the rolling bar. The end caps have outer recesses 212 that can accommodate protrusions 214 from a pair of housing end caps 210. The housing end caps 210 are fastened to the two ends of the housing 202 and permit the rolling bar end caps (and therefore the rolling bar itself) to rotate freely within the housing 202 along an axis defined by the protrusions 214 which will be parallel to the axes of the two tubes 102, 104.

The slot 304 provides an entry and exit point to a channel 300 that wraps underneath the rolling bar 206.

The outer shape of the tensioning bar is shown as a teardrop shape however it could be provided in any suitable shape to meet the aesthetic needs of the customer.

Turning now to FIG. 4, an embodiment of the fabric 400 is shown. One end 402 of the fabric 400 is to be coupled to first tube 102 and the other end 404 of the fabric 400 is to be coupled to the second tube 104. The fabric 400 is continuous and comprises three portions. In practice, the fabric could be a single sheet or could be multiple sheets adhered or fused together.

In a preferred embodiment, the fabric 400 comprises portions A, B and C wherein portions A and B meet at a first meeting line 406 and portions B and C meet at a second meeting line 408. The meeting lines are generally parallel to the tubes 102, 104. Portions A and C are transparent or translucent while portion B is either translucent (preferably at least more opaque than portions A and C) or opaque (e.g., what is referred to in the art as a “blackout”) and is sufficiently opaque to provide a desired amount of privacy when it covers a window. An alternative approach is to have portions A and C as translucent and portion B as blackout, or any other desired arrangement. In summary, portion B is preferably provides more privacy than portions A and C.

Preferably each one of the portions A, B and C is of a length equal to the window height. However, the length of these portions could be slightly less than the window heights since the assembly comprising the tubes and brackets will typically overlay an upper portion of the window. Thus, the length of these portions could be a few inches (e.g. about 4 inches) less than the window height without loss of overall function. In these cases, what is desired is that the length of the portion B along with the height of the tube assembly is about the same as the window height, and that portions A and C are at least as long (as any excess of A and C can be left rolled around the tubes). Optionally, portions A and/or C could be made slightly longer than required so that the fabric is never required to fully unroll from the first tube 102 or second tube 104, as applicable. This can provide additional durability of the fastening of the fabric to its respective tube.

Turning now to FIG. 5A, FIG. 5B and FIG. 5C, the window covering is viewed in cross-sectional side view and the blind is shown at three (of many) positions. In FIG. 5A, the window covering is rolled (the tensioning bar 122 is at its highest point) and in FIGS. 5B and 5C, the window covering is fully unrolled (the tensioning bar 122 is at its lowest point) but the amount of privacy has varied.

The tensioning bar 122 is disposed intermediate the two ends of the fabric and the fabric freely rolls or slides along the rolling bar 206 within the channel 300 with little resistance. The tensioning bar 122 preferably has sufficient weight to always slide to the lowest point of the fabric that has been unrolled, which will now be described.

In the fully rolled position of FIG. 5A, the fabric 400 is partially rolled around the first tube 102 and partially around the second tube 104. The combined amount of rolling is sufficient for the tensioning bar 122 to be disposed proximate the tubes, in what would be considered a desirable uppermost position.

The drive source D may include a stop such as a mechanical stop of a chain drive or a programmable stop of a motor to prevent the tensioning bar from colliding with the tubes.

With respect to the embodiment of the fabric 400 shown in FIG. 4, in the fully rolled position as shown in FIG. 5A, portion A is rolled around the upper tube 102 and portions B and C are rolled around the lower tube 104. The opposite could be provided as well: portions A and B could be around one tube and portion C could be around the other tube, without loss of function. Furthermore, it can be seen that in the preferred embodiment, the fabric drops off the side of the rollers that is closer to the window. This results in the two drops of fabric being substantially adjacent to one another, resembling a single fabric layer. It is possible to otherwise permit the fabric to drop on opposing sides of the tubes while still providing the privacy features described herein.

A small amount of portion A and portion B are left unrolled so that the tensioning bar does not collide with the second tube 104, and so that the meeting line 406 rests within the channel 300.

Thus it is apparent that for the embodiment of the fabric 400 shown in FIG. 4, the length of the fabric that is rolled around the two tubes 102, 104 is unequal; there is approximately twice the amount of fabric rolled onto the second tube 104 than on the first tube 102. This facilitates movement of the window covering as now described.

From the position of the blind of FIG. 5A, the drive source rotates the second tube 104 in an unrolling direction (clockwise in the illustrated embodiment) and the gear 112 of the second tube 104 drives the gear 110 of the first tube 102 in the opposite direction (counter-clockwise in the illustrated embodiment) to cause further unrolling of the fabric. The fabric simultaneously unrolls from both the first tube 102 and the second tube 104 albeit in opposite directions. Thus meeting line 406 should not move significantly within the channel during this process.

The drive source D is permitted to continue rotating the tubes so that once the fabric 400 has fully unrolled from the first tube 102, the tensioning bar 122 will be at the bottom of the window, i.e., it will reach its lowest extent. In this position, which is what is shown in FIG. 5B, the window covering is in its privacy position in which portion B will extend from the second tube 104 down to the tensioning bar 122 and the portion A will extend from the tensioning bar 122 up to the first tube 104

Preferably, there is a preset stop configured for the drive source so that the drive source will stop or pause at this position, making it easy for the user to retain the window covering in this position if desired.

However, the user can then cause the drive source to continue driving the second tube 104 in the same clockwise direction as shown in FIG. 5B. At this transition point, portion A is caused to roll onto the first tube. As can be seen in FIG. 5A, FIG. 5B and FIG. 5C, the portion A was originally unrolling off of the left side of the first tube (based on the viewpoint of the images) and is now rolling onto the right side of the first tube (again, based on the same viewpoint).

After this transition point, what is shown in FIG. 5C is that as portion A is being rolled around the first tube 102, the portion B is passing from the side S1 through the channel 300 to side S2, and the portion C is becoming exposed along side S1. Once portion B is half at side S1 and half at side S2, rotation may stop, as the window covering as a whole has now achieved all possible privacy positions. In other words, continuing exposure of portion B on side S2 would only duplicate what has already been provided on side S1 in terms of privacy along the lower portion of the window in the same direction would only C fully unrolls from the second tube 104. Thus, the drive source may be caused to cease rotation in the unrolling position. The user can then choose to retain the position or reverse the drive source to retract the window covering back to the position of FIG. 5B and then toward the position of FIG. 5A (or intermediate points between).

The reader will appreciate, then, that this operation will result in the blind being able to move from fully rolled (FIG. 5A) to fully unrolled with complete privacy (FIG. 5B), then for the tensioning bar to rest at its lowermost position while the fabric continues to slide within its channel to partial lower-privacy (FIG. 5C), and with the drive source D causing rotation in the same direction.

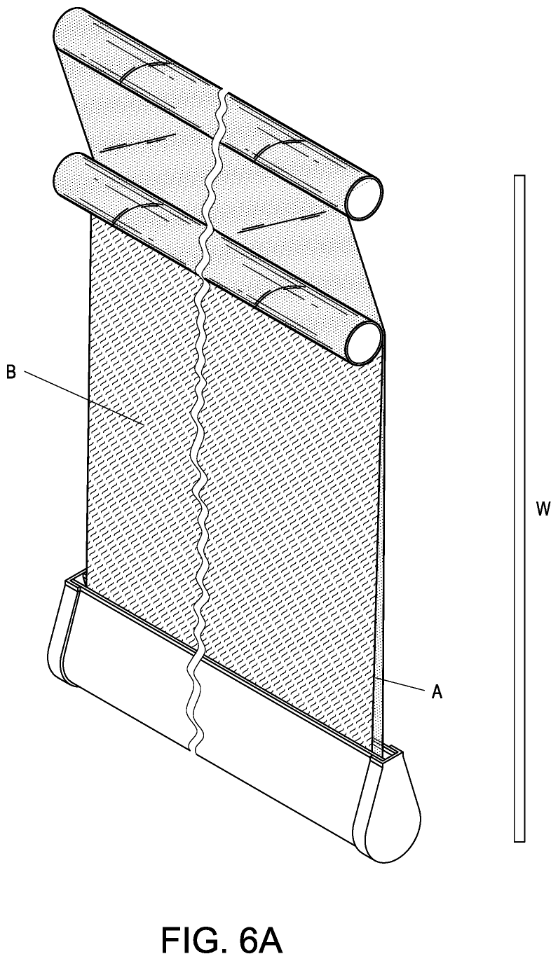

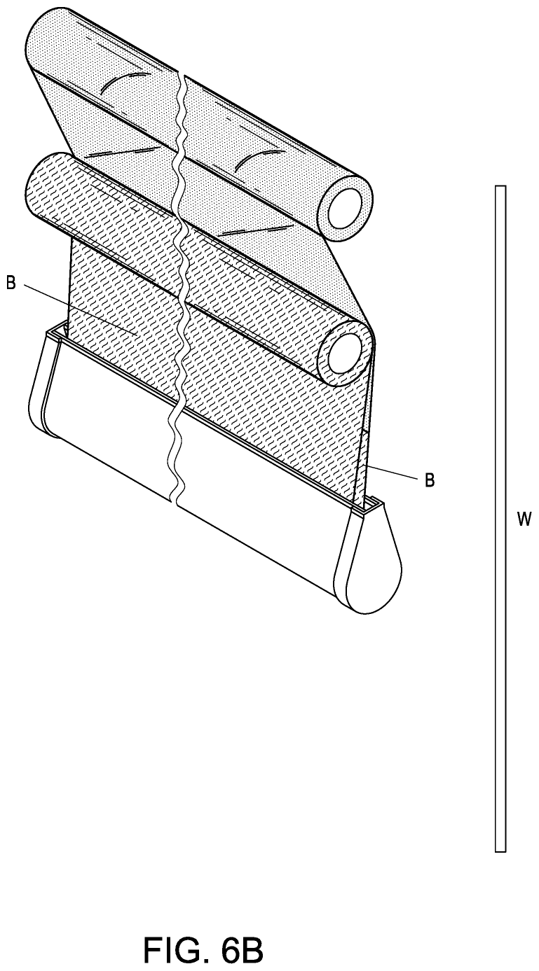

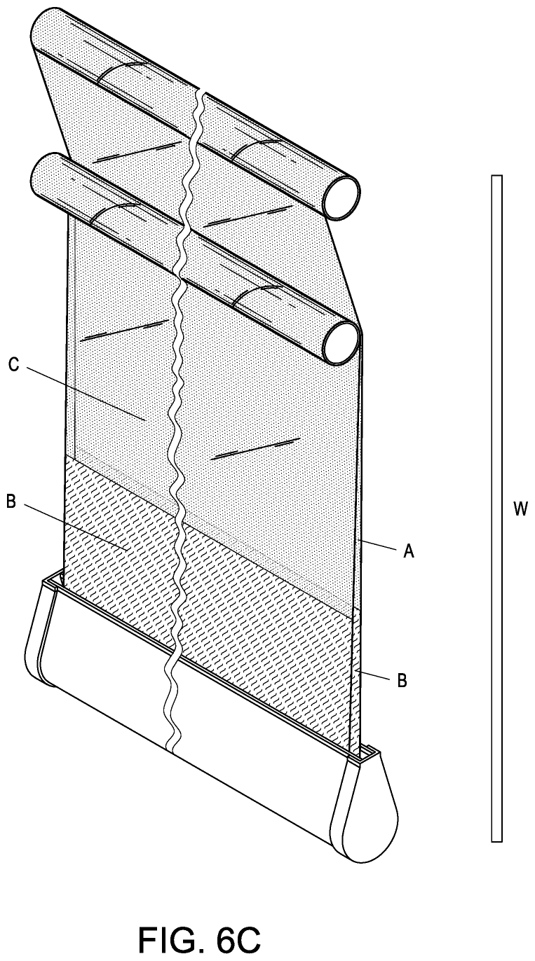

Thus, when considered along with the illustrations of FIGS. 5A, 5B and 5C, the reader will appreciate that the presently disclosed blind is capable of being rolled to a desirable position in which any of the following can be achieved: fully exposing the window of length W (the position of FIG. 5A), fully covering the window for complete privacy (FIG. 6A along with FIG. 5B), partially covering the window along an uppermost portion (FIG. 6B intermediate the positions of FIG. 5A and FIG. 5B), and partially covering the window along a lowermost portion (FIG. 6C along with FIG. 5B or FIG. 5C).

In particular, taking into consideration the illustrations of FIG. 5B and FIG. 5C, the reader will appreciate that with the tensioning bar at its lowermost position (which typically will be proximate the bottom of the window), the fabric can slide within the channel such that any of the following example arrangements may be true:

| | | | As observed by a |
|---|---|---|---|
| | Side S1 | Side S2 | person |
| 1^{st} Arrangement | Opaque portion B | Transparent portion A | Fully Opaque |
| 2^{nd} Arrangement | Uppermost portion is C | Uppermost portion is A | Upper portion of |
| | and lowermost portion | and lowermost portion | window is exposed |
| | is B | is B | and lower portion of |
| | | | window is covered |
| | | | (opaque) and the |
| | | | portion of the window |
| | | | being covered is the |
| | | | higher part of portion |
| | | | B along either S1 or |
| | | | S2 |

The reader will also appreciate that with the tensioning bar at any position other than its lowermost position, a desirable upper portion of the window can be covered.

In the embodiments shown, the tubes 102 and 104 are disposed one above the other to reduce the space between the two portions of the fabric that extend toward the tensioning bar. However, a skilled reader will appreciate that other alternatives are possible if this characteristic is not desired or needed.

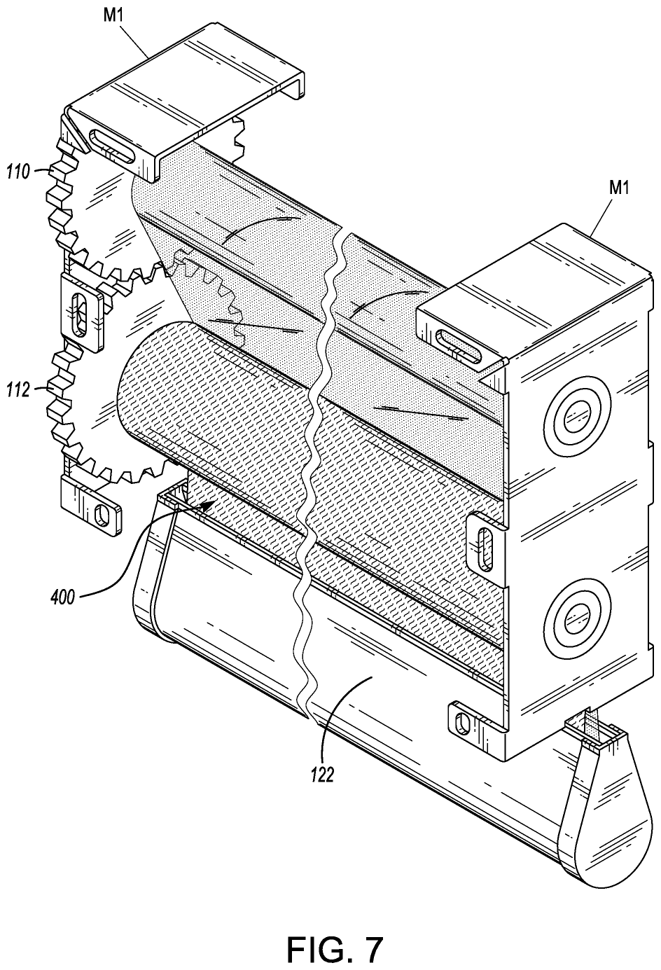

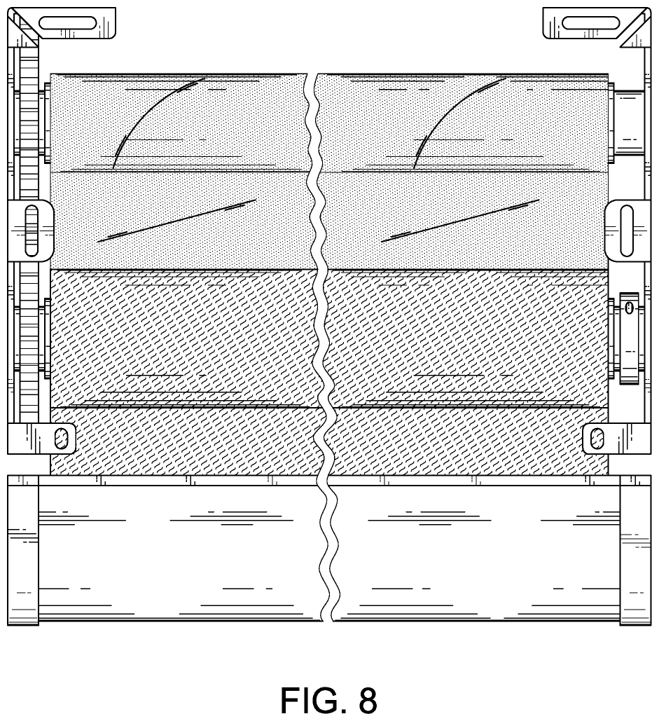

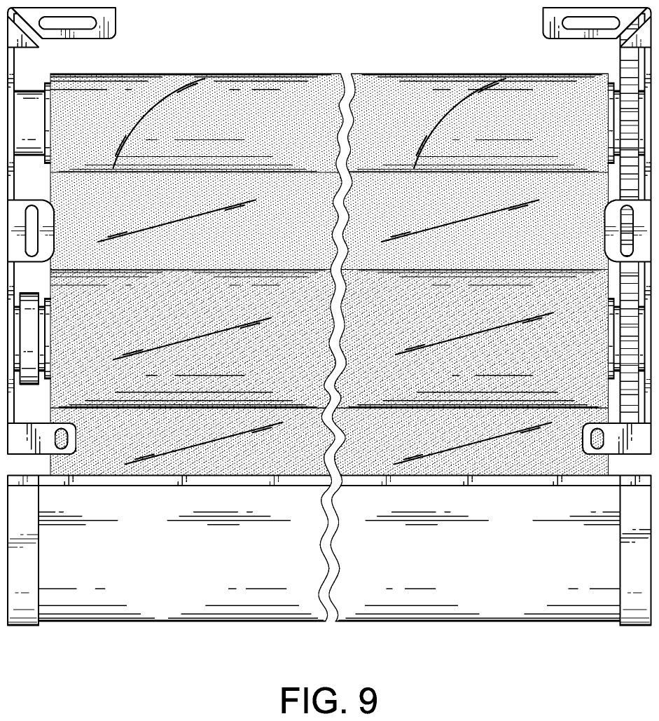

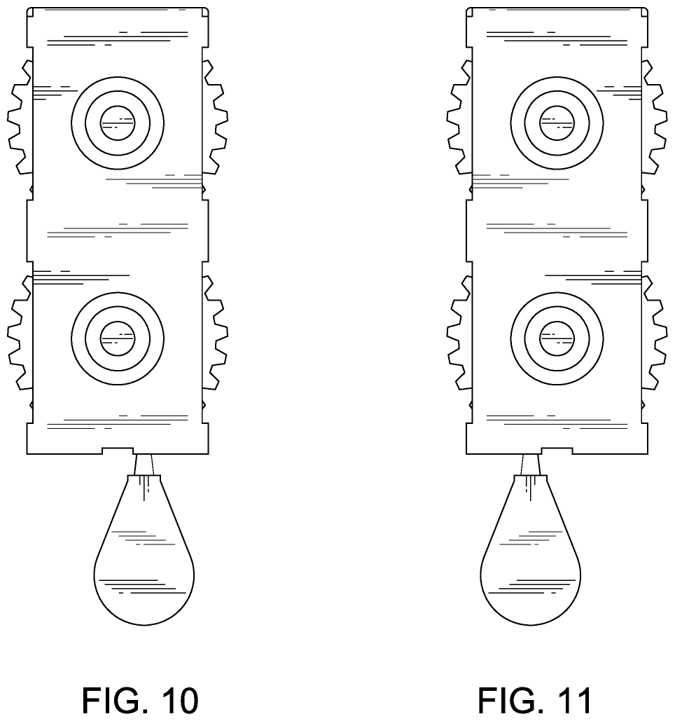

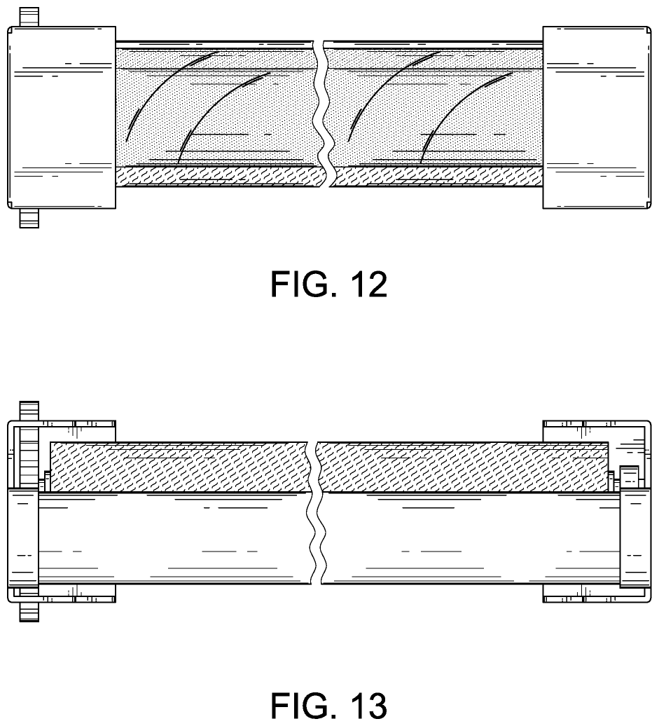

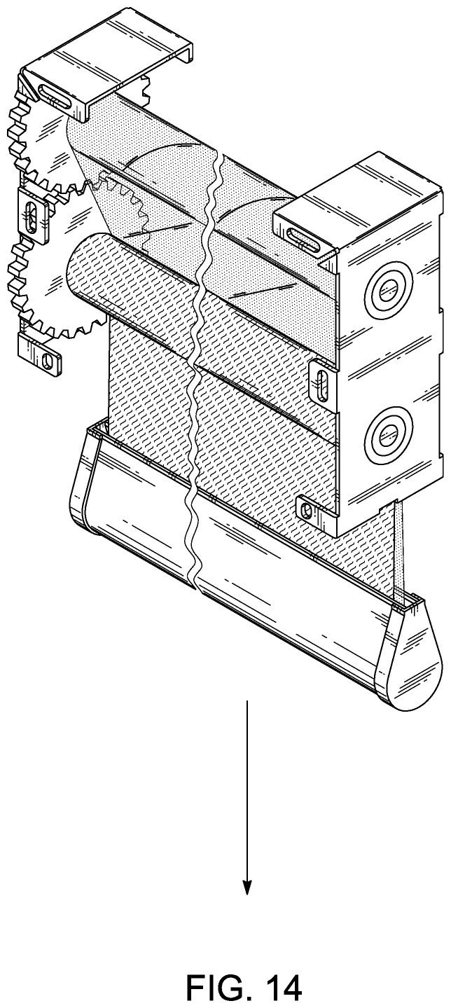

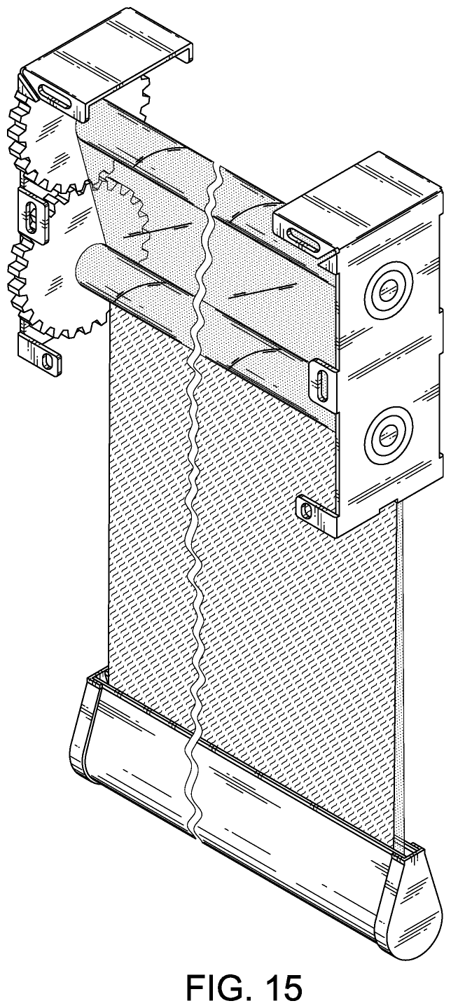

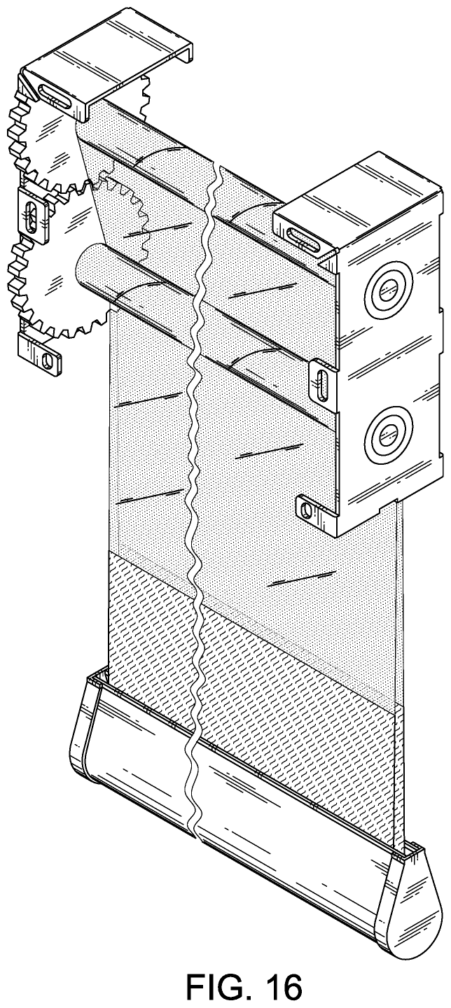

A finished article embodying the above teachings is shown in FIGS. 7 to 16. In these figures, the two crosshatching patterns are intended to convey varying translucency levels, as described above. As can be seen in the extended positions of FIGS. 14, 15 and 16, the window covering can be adjusted to varying amounts of desired privacy.

Yet further modifications could be implemented by a person of ordinary skill in the art in view of the present disclosure, which modifications would be within the scope of the present technology.

Although the foregoing has been described with reference to certain specific embodiments, various modifications thereto will be apparent to those skilled in the art without departing from the spirit and scope of the invention as outlined in the appended claims.

1. A window covering comprising:
a first tube and a second tube rotatably coupled to the first tube, the first tube and the second tube disposed along parallel axes;
a fabric fastened at a first end to the first tube and at a second end to the second tube;
a tensioning bar slidably disposed along the fabric in between the first end and the second end; and
a bracket to suspend the first tube and the second tube above the tensioning bar.

2. The window covering of claim 1, wherein the first tube and the second tube each have a gear disposed along its respective axis, wherein the gear of the first tube is coupled to the gear of the second tube.

3. The window covering of claim 2, wherein one of the two gears are driven by a drive source.

4. The window covering of claim 3, wherein the drive source is an electric motor.

5. The window covering of claim 3, wherein the drive source is a clutch rotated by a manually drive.

6. The window covering of claim 1, wherein the tensioning bar comprises an upper slot and a channel formed from the upper slot around a rolling bar.

7. The window covering of claim 1, wherein the first tube, the second tube and the tensioning bar are substantially similar in length.

8. The window covering of claim 1, wherein the fabric comprises three portions.

9. The window covering of claim 8, wherein the three portions comprise a first portion from the first end to a first meeting line, a second portion from the first meeting line to a second meeting line, and a third portion from the second meeting line to the second end.

10. The window covering of claim 9, wherein the first portion and the third portion are translucent and the second portion is more opaque than the first portion and the third portion.

11. The window covering of claim 9, wherein each of the three portions is at least as long as a height of a window to be covered.

12. The window covering of claim 9, wherein a length of the second portion plus a height of a tube assembly comprising the first tube and second tube is at least the height of a window to be covered.

13. The window covering of claim 1, wherein when the first tube and the second tube are rotated, the fabric unrolls and the tensioning bar lowers until the fabric has fully unrolled from either the first tube or the second tube.

14. The window covering of claim 9, wherein when the tensioning bar has reached a lowest extent, rotation of the first tube and second tube cause the fabric to traverse the tensioning bar passing the second portion from a first side of the tensioning bar to a second side of the tensioning bar.

15. The window covering of claim 9, wherein the window covering can be configured to fully obscure a window, fully expose the window, or to obscure only a lower portion of the window.
